(19) United States
(12) Patent Application Publication
(10) Pub. No.: US 2014/0109197 A1
(43) Pub. Date: Apr. 17, 2014

(54) METHOD AND A SYSTEM TO GENERATE AND MANAGE NATIVE APPLICATIONS

(71) Applicants: Michael Schneider, Madrid (ES); Daniel Jesús Coloma, Madrid (ES)

(72) Inventors: Michael Schneider, Madrid (ES); Daniel Jesús Coloma, Madrid (ES)

(73) Assignee: TELEFONICA, S.A., Madrid (ES)

(21) Appl. No.: 14/111,871

(22) PCT Filed: Mar. 30, 2012
(86) PCT No.: PCT/EP12/55792

§ 371 Date: Dec. 27, 2013

(30) Foreign Application Priority Data
Apr. 15, 2011 (ES) P201130603

(51) Int. Cl. G06F 21/62; H04L 29/06

(52) U.S. Cl. CPC G06F 21/6281; H04L 63/0876
USPC 726/4

(57) ABSTRACT

The method comprises:
a) creating, an application developer, a run time based generic application;
b) generating a plurality of native applications for different corresponding operating systems by bundling said generic application together with a runtime for every supported operating system, or OS, said runtimes handling OS Device APIs and Network APIs; and
c) managing said native applications by at least their storage in a database and/or their distribution to computing devices.

The system comprising means for performing said steps b) and c) of the method of the invention.

### FIELD OF THE ART

The present invention generally relates, in a first aspect, to a method to generate and manage native applications, based on the bundling of a generic application with adequate runtimes, and more particularly to a method comprising using runtimes handling Network APIs.

A second aspect of the invention concerns to a system to generate and manage native applications adapted for implementing the method of the first aspect.

### PRIOR STATE OF THE ART

Developing applications for mobile devices has been an extremely time consuming task because developers needed to create multiple versions of the same application for different devices and/or Operating Systems (FIG. 1).

Due to this situation, the concept of cross-OS or cross-device Runtime was created. A runtime allows the same application to be developed once and deployed in multiple OS/devices provided the appropriate runtime is provisioned in the targeted devices (FIG. 2).

However, the paradigm that was pushed by JavaME [1] firstly and now by WAC [2] has suffered some practical problems:
Not all the devices have the appropriate Runtime provisioned.
Runtimes supplied by different ISV or OEMs are implemented in different manners.

Due to those factors, when a developer created an application for a runtime, he was not sure if the application was going to run on the targeted device because of the lack of runtime or the differences with the runtime he tested and verified the application.

In order to avoid those problems, some initiatives have been created in order to bundle the application with the required runtime (e.g. Phonegap [3]) and creating (based on a unique developer application) multiple native applications (one per platform). By delivering a bundle including the two components, the developer ensures that the application will run on the device regardless of the OS, model and the provisioning of the WRT (FIG. 3).

Although the solution depicted in FIG. 3 could look like a good approach, it is again bringing back to the developer the problem of OS and device heterogeneity: Developers need to use different versions of the runtime for every OS and device.

In order to mitigate that problem, another iteration called “Phonegap Build” [4] has been created by PhoneGap (FIG. 4). Developers can just submit their application created for the runtime, that application will be converted and packaged for the different operating systems.

Problems with existing solutions:

Although developers can now get native apps based on a unique runtime application, the current solutions are only considering the inclusion of runtimes that abstract the heterogeneity of Device APIs. However, developers are not only interested in an abstraction layer in that area, but in some others such as:
Network APIs: The usage of resources available in the network is one of the features developers are also interested in (e.g. in-app billing, user identity . . . ). In this case, the handling of the security (authentication and authorization) is especially critical, as the flows may be security sensitive, complex and extremely difficult to be managed by developers.
Security: Different OSs have different security models, and some of them are not secure enough to satisfy the user needs. None of the current solutions provide a common security experience on top of different OS.

### DESCRIPTION OF THE INVENTION

It is necessary to offer an alternative to the state of the art which covers the gaps found therein, particularly those existing in runtimes used for generating native applications regarding the abstraction layers they don't include in the above mentioned proposals.

To that end, the present invention concerns, in a first aspect, to a method to generate and manage native applications, comprising:
a) creating, an application developer, a run time based generic application;
b) generating a plurality of native applications for different corresponding operating systems by bundling said generic application together with a runtime for every supported operating system, or OS, said runtimes handling OS Device APIs; and
c) managing said native applications by at least their storage in a database and/or their distribution to computing devices.

In the method of the first aspect of the invention, differently from known proposals, said step b) further comprises bundling said generic application together with a runtime handling Network APIs.

For different embodiments of the method of the first aspect of the invention, it further comprises, for the generation of each of said native applications at step b), performing one or more of the next further actions:
adding a security framework for restricting the access to said OS Device APIs;
adding a security framework for controlling the authentication and authorization of the usage of said Network APIs; and
applying at least one of a set of transformation rules including: application signing and embedding developer credentials for Network APIs usage.

Other embodiments of the method of the first aspect of the invention are described with reference to appended claims 3 to 14, and in a subsequent section related to the detailed description of several embodiments.

A second aspect of the invention relates to a system to generate and manage native applications, comprising means for performing at least steps b) and c) of the method of the first aspect

Some embodiments of the system of the second aspect of the invention are described with reference to appended claims 16 to 18, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 shows a prior art mechanism regarding Native Apps development where multiple versions of the same application are originally created;

FIG. 2 shows another prior art proposal concerning Runtime Apps Development where runtimes are provisioned in the targeted devices;

FIG. 3 illustrates another prior art scenario where the runtimes are embedded with the application by the developer;

FIG. 4 schematically shows a prior art system which differs from the one of FIG. 3 in that the runtimes embedding is performed by means of an application builder receiving the application from the developer;

FIG. 5 shows, at a schematic level, the architecture of the system of the second aspect of the invention used for implementing the method of the first aspect, for an embodiment;

FIG. 6 shows a High Level Workflow representative of an embodiment of the method of the first aspect of the invention;

FIGS. 7 to 11 sequentially show steps 1 to 5 of an application generation process according to the method of the first aspect of the invention, for an embodiment, ending, at step 5 of FIG. 11, with the creation of a native application;

FIG. 12 schematically shows the created native application once installed on the device/OS after an application download process followed according to an embodiment of the method of the invention;

FIG. 13 shows the security configuration shown to the device user when the application is executed for the first time, as per an embodiment of the method of the first aspect of the invention;

FIG. 14 schematically shows the usage of the Device APIs by the application as per an embodiment of the method of the first aspect of the invention;

FIG. 15 shows the usage of Network APIs by the downloaded application according to an embodiment of the method of the first aspect of the invention; and

FIG. 16 shows an example of a Network API Authentication/Authorization workflow as per an embodiment of the method of the first aspect of the invention, in order to access the Network APIs as shown in FIG. 15.

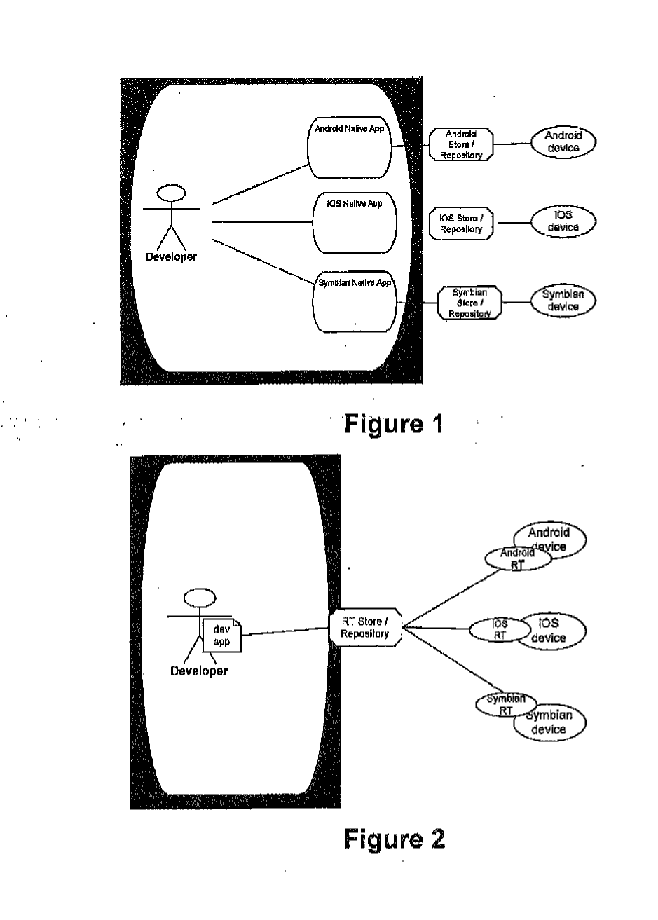

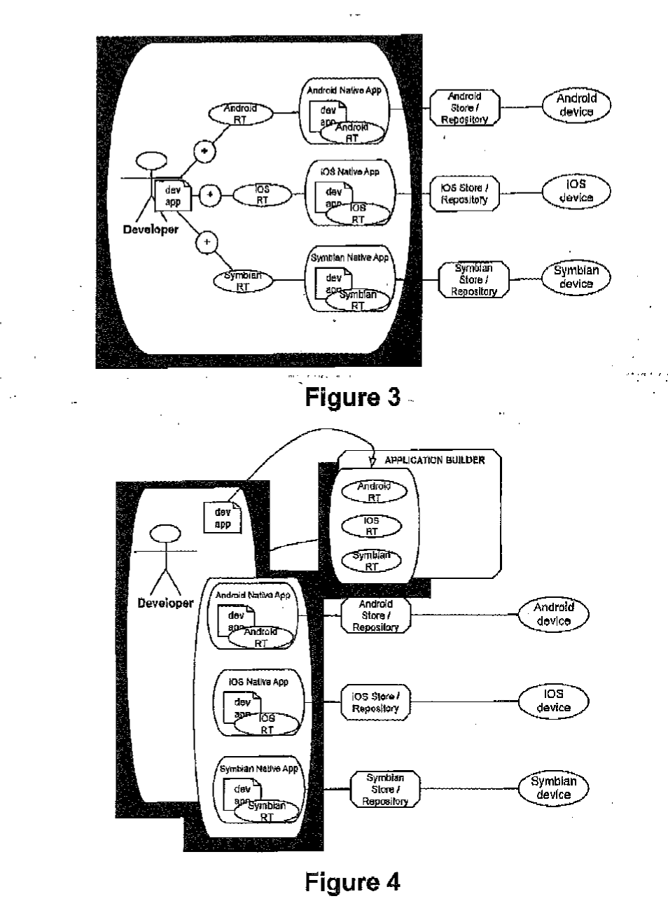

### DETAILED DESCRIPTION OF SEVERAL EMBODIMENTS

This proposal goes beyond the existing solutions by defining an application processor and distributor that based on a universal application format creates different bundles that comprise the application and runtime for every targeted OS.

The developer can create the application based on the runtime specifications (developer application) and using only the technology the runtime provides. When the application is ready, the developer can submit the application to the system that, for an elaborated embodiment:
Checks the validity of the application.
Bundles the developer application together with the runtime for every supported OS. The runtime handles:
   The binding to the OS Device APIs.
   A consistent security model for accessing the Device APIs.
   The binding to the Network APIs.
   The Authentication and Authorization for accessing the Network APIs.
Applies a set of transformation rules that prepare the bundles created as defined above so they are ready for installation in every supported OS/device. For instance, application signing and embedding developer credentials for Network APIs usage.
Returns the native applications generated to the developers so that they can upload them to the stores they are interested in. Additionally, the system may expose the application to end-users: when a user wants to download an app, the system, based on the device being used, serves the right application version.

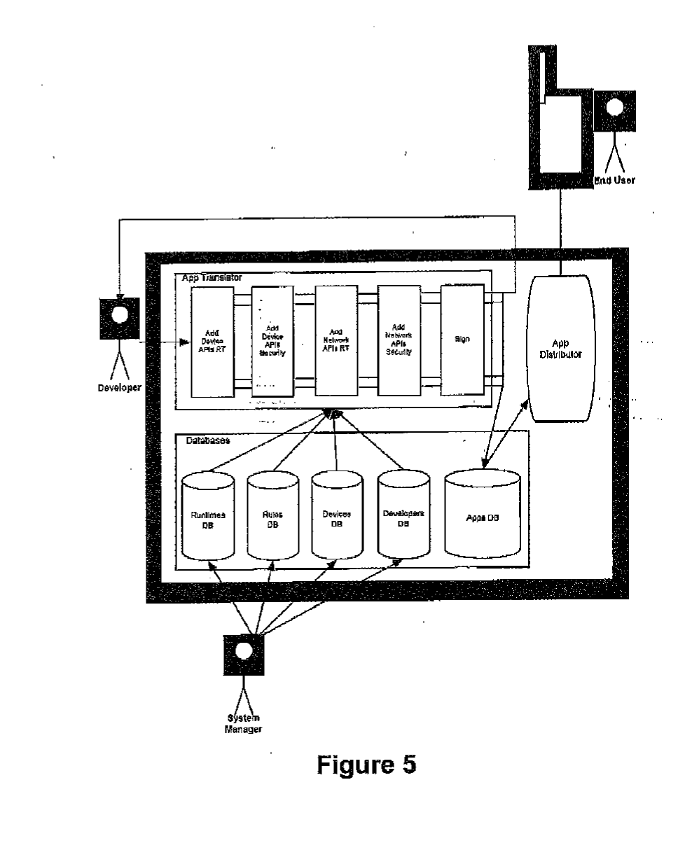

FIG. 5 represents graphically the system of the second aspect of the invention, used for implementing the method of the first aspect.

The components that make up the system, for the illustrated embodiment, are:
Databases: Manage different information needed for the right behaviour of the system.
   Runtimes DB: Database in which the different runtimes to be embedded in the native applications are available.
   Rules DB: Database in which the rules to be applied for the native application generation are available. For instance, the rules for a particular OS may indicate whether application signing is needed or not or which APIs are supported.
   Devices DB: Database in which the information about the supported OS and devices is stored.
   Developers DB: Database in which developer information and credentials (e.g. developer keys) are available.
   Applications DB: Database in which all the applications (either authored by developers or generated by the system) are available.
App Translator: Responsible for converting the developer application (authored in the Runtime) to multiple native versions (one per supported OS).
   Device APIs RT: Includes the component that binds the RT Device APIs calls to the native OS.
   Device APIs RT Security: Includes the layer that restricts the access to the Device APIs depending on the administrator choices and level of trust of the developer.
   Network APIs RT adder: Includes the component that binds the RT Network APIs calls to the APIs exposed in the network (e.g. from JavaScript to HTTP REST).
   Network APIs RT Security: Includes the layer that controls that is responsible for handling the authorization and authentication for Network API usage.
   Signing: Signs the application with the developer credentials or/and the distributor signature.
App Distributor: Responsible for handling application download requests. Based on the request headers identifies the application that should be deployed in the customers' device.

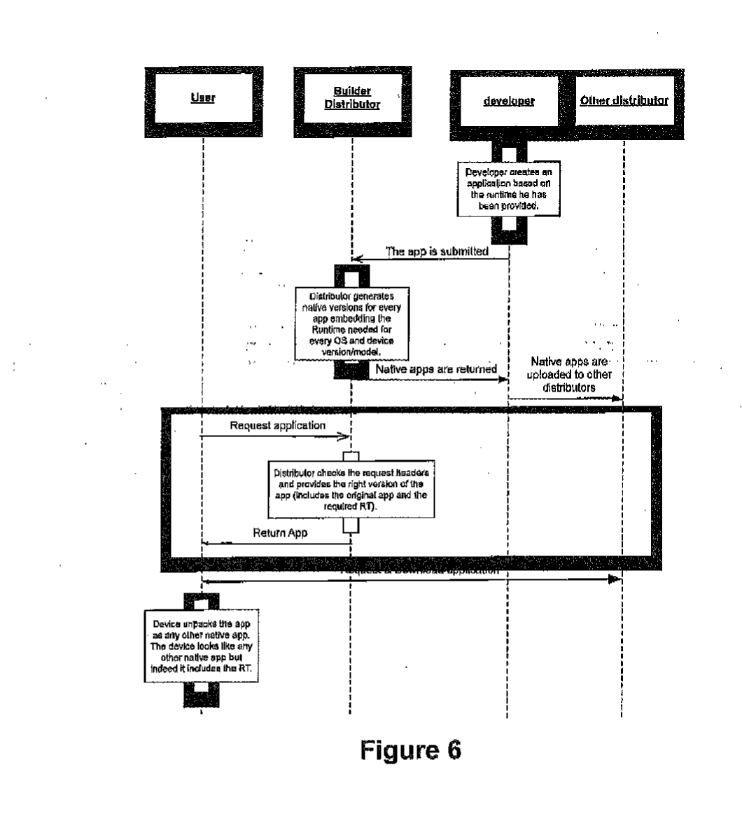

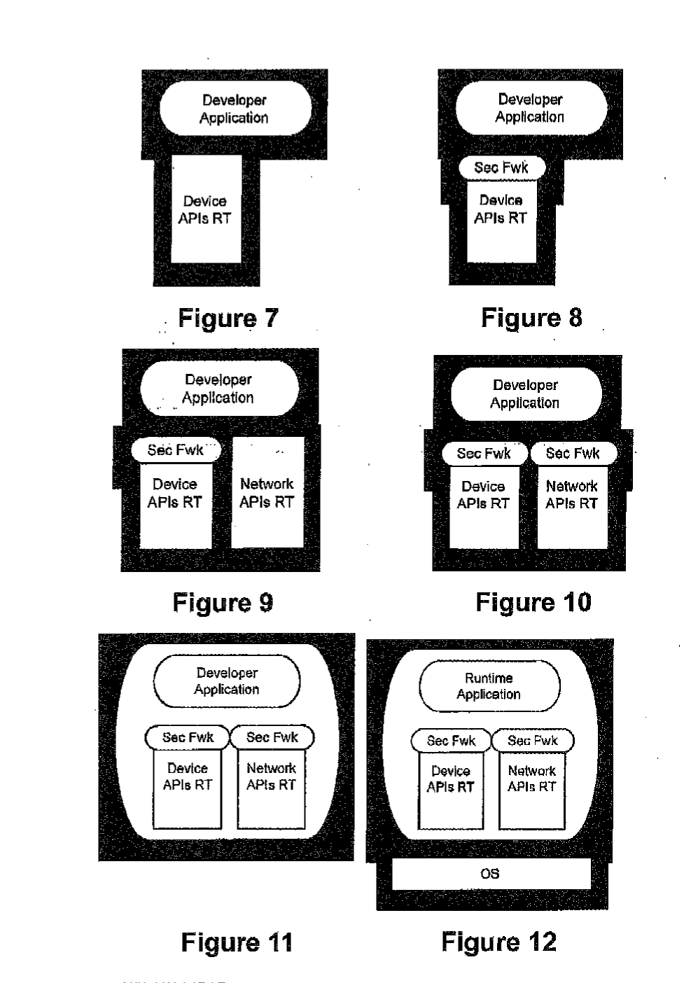

FIG. 6 depicts a high level diagram of the flow that is performed when an application is submitted by the developer to the distributor, according to an embodiment of the method of the invention, where legends indicated therein must be textually interpreted as actions performed between the device user, a builder distributor (part of the system of the invention), the application developer, and other distributors, according to a sequence going from up to down in the diagram, and following the directions of the depicted arrows.

Detailed Workflow:

Next, a more detailed description of the key workflows that are performed according to the method of the first aspect of the invention and by the system of the second aspect, or by the applications generated thereby, is given.

Application generation:
Step 0: The system reads the developer profile, the supported OS, RTs and security settings and based on that, it determines what is the workflow that the application should go through.
Step 1: For every supported OS (according to the workflow determined in step 0), the right runtime that “translates” the RT application API calls to the OS APIs is applied. After this step, the original application has led to N versions of the application, one for every supported OS/Platform.
Step 2: The system adds, for every application version the security framework determined during STEP 0 and that has a consistent UX for every OS. The framework to be applied may depend on the level of trust of the developer (e.g. apps developed by the distributor itself may have fewer prompts). This framework may still be adapted/customized depending on the end-user choices.
Step 3: The system adds, for every application version the appropriate libraries to bind the calls that the runtime app makes to network resources to the implementation of the network resources that the distributor has. For instance, a JavaScript call in the runtime may need a translation to the native OS and then link to the Network resources (e.g. HTTP calls).
Step 4: The system adds, for every application version the appropriate security framework for performing network API and application authentication and authorization. This framework may handle things such as validity of tokens, prompting regime, user authentication needed. During this step the developer credentials as well as the distributor certificates/credentials, are added.
Step 5: If any destination OS requires application signing (according to the workflow defined in the step 0), the app is signed for that OS.
Step 6: All the generated apps will be stored in the system in the applications database. The applications are also returned to the developer in case he is interested in uploading them directly to other application distributors.

Application download:
Step 0: A user requests an application from the store; a unique ID identifies the application. The device provides in the request the information about the platform/OS used by device.
Step 1: The App distributor module finds the right application version for the targeted device/platform.
Step 2: The App is delivered to the device, which installs the application on top of the targeted OS.

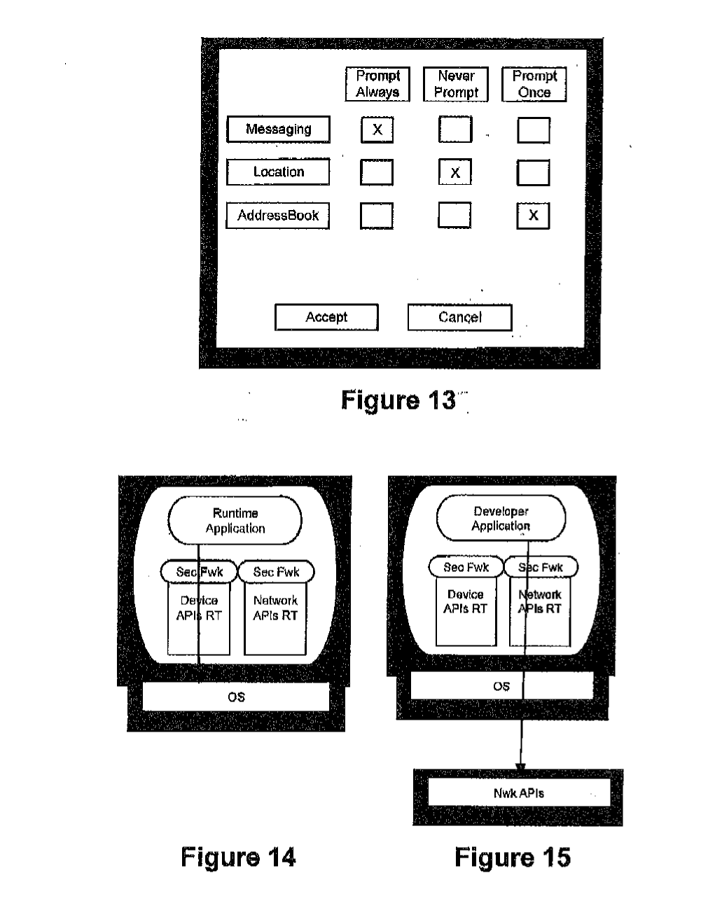

Application execution:
Step 0: When the application is executed the first time, it notifies the user about the network and device APIs the app is going to use and might allow him (depending on build system settings) to customize the prompting regime linked to them (FIG. 13).
Step 1: When the application tries to use a device API, it checks whether prompting is needed. If so, the Device APIs RT Sec Framework asks the user for authorization. In case he allows it or no prompting is needed, the API usage will be authorized and the native capability will be granted and used (FIG. 14).
Step 2: When the application tries to use a network API, the security framework checks if the usage of that API has been authorized before by the end-user (FIG. 15).
   Step 2A: If the usage has been authorized before, the framework already knows the developer token as well as the authorization token. Both are included in the network request that is created based on the original developer call.
   Step 2B: If the usage has not been authorized or the authorization has expired the framework needs to check the usage authorization of the APIs, in order to do so, for instance, the framework may prompt the user and ask him for his credentials for accessing that network resource. If the credentials are authenticated, an authorization code is returned to the runtime network security framework. If the authorization is not successful the request is rejected, if it is successful the developer request is further processed as specified in step 2A.

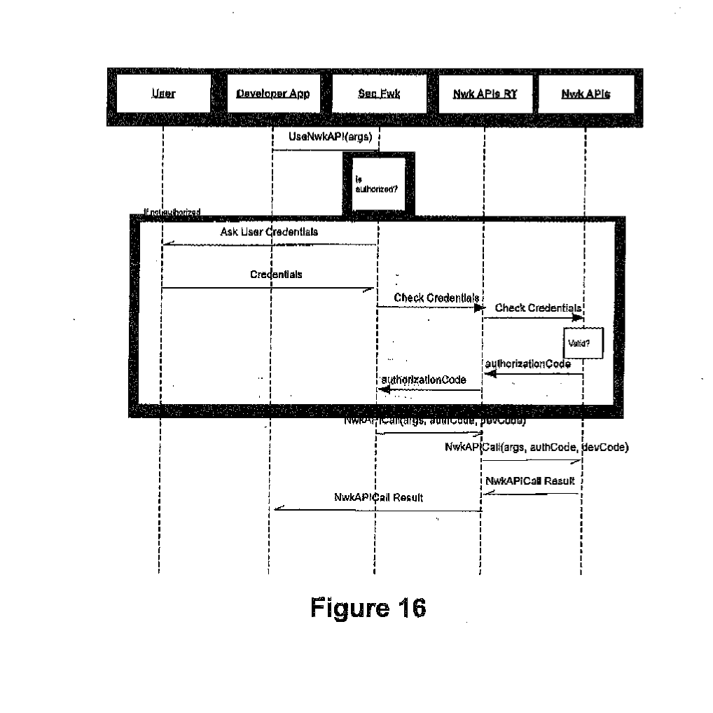

FIG. 16 describes an example of this security authentication flow, according to an embodiment of the method of the invention, where legends indicated therein must be textually interpreted as actions performed between the device user, the application, the Network Security Framework, the Network APIs Runtime and the Network APIs, according to a sequence going from up to down in the diagram, and following the directions of the depicted arrows. Please note that the solution defined in this invention is flexible enough to accommodate the desired security flow, as it will be injected in the application generation step according to the needs of the application distributor.

A person skilled in the art could introduce changes and modifications in the embodiments described without departing from the scope of the invention as it is defined in the attached claims.

Advantages of the Invention:

The applications that can be developed by this system are richer than the ones other similar solutions are allowing today: The apps can use not only device APIs but also Network APIs with a very simple User Experience.

The solution is extremely simple for developers, they create one application using a single technology and multiple variants of that application are created. Additionally the runtime handles all the security, which is usually one of the most complicated areas to deal with by developers (especially in the network APIs).

The Return of investment of application development also increases. Developers can upload the generated apps to multiple distributors and also use them in the distributor that the builder includes.

The security is also strengthened: the application developer does not need to take care of application signing, authentication or authorization. The builder and distributor manage all those aspects, which minimize the opportunity for malware development and proliferation.

Technical Definitions:

Developer Application: Is the applications that are directly authored by the developer. In the case of this invention, the developer applications are built using a Runtime technology.

Native Application: Application that is built using the native capabilities of a device (e.g. Dalvik in Android Devices or iOS in iPhones).

Runtime: Element that allows the execution of applications. A runtime is typically built in a cross-platform manner, so that the same app can be deployed in any device equipped with the adequate runtime.

Network APIs: APIs that allow usage of network resources, those resources are typically exposed through HTTP Interfaces. However, different shim layers can be built on top of them to facilitate access to them (e.g. JavaScript APIs or Native libraries).

Authentication: It is a process by which it is verified that someone is who he or she claims they are. For instance, in the case of network APIs, it is required that the application user is authenticated in order to allow the application to use the end-user account (e.g. charging him for message sending).

Authorization: It is a process by which its checked if someone has the right to access a resource. For instance, in the case of network APIs it may be achieved to the use of an authorization token that is linked to the developer. I.e. if the token is valid, that means that the developer has the right to Access that resource.

### ACRONYMS AND ABBREVIATIONS

API Application Programming Interface

App Application

HTTP Hyper Text Transfer Protocol

iOS iPhone Operating System

ISV Independent Software Vendor

JS JavaScript

OEM Original Equipment Manufacturer

OS Operating System

RT Runtime

UX User Experience

WAC Wholesale Application Community

### REFERENCES

[1] Java ME: http://www.oracle.com/technetwork/java/javame/overview/index.html

[2] WAC: http://wacapps.net

[3] Phonegap: http://www.phonegap.com/

[4]Phonegap Build: https://build.phonegap.com/

1.-14. (canceled)

15. A method to generate and manage native applications, comprising:
a) creating, by an application developer, a run time based generic application;
b) generating a plurality of native applications for different corresponding operating systems by bundling said generic application together with a runtime for every supported operating system, or OS, said runtimes handling OS Device APIs; and
c) managing said native applications by at least their storage in a database and/or their distribution to computing devices;
wherein the method is characterized in that said step b) further comprises:
bundling said generic application together with a runtime handling Network APIs to use resources available in the Network; and
performing at least one of the next further actions for the generation of each of said native applications providing a security handling thereof:
adding a security framework for restricting the access to said OS Device APIs;
adding a security framework for controlling the authentication and authorization of the usage of said Network APIs; and/or
applying at least one of a set of transformation rules including: application signing and embedding developer credentials for Network APIs usage,
wherein said controlling of the authentication and authorization of the usage of said Network APIs is performed by means of asking, by said security framework, to an user, to provide credentials for accessing a network resource, said credentials being used to obtain an authentication code from said network resource and used in turn to access functionality of said resource by means of invoking the corresponding Network API.

16. The method according to claim 15, further comprising checking the validity of said generic application before and as a condition to start said step b).

17. The method according to claim 15, comprising creating said generic application at step a) based on runtime specifications and using only the technology runtime provides.

18. The method according to claim 15, comprising, for every of said native application generation, performing said step b) for carrying out said bundling of runtimes or said bundling of runtimes and further actions, according to a workflow.

19. The method according to claim 18, comprising starting said workflow by reading a delivered developer profile, the supported OSs, runtimes and security settings, and based on that, determining what is the workflow that the generic application should go through, said determination including the selection of the runtimes, security frameworks and transformation rules to be applied, from a plurality of runtimes, security frameworks and transformation rules, and the order of their performing.

20. The method according to claim 19, wherein the selection of said OS device APIs security frameworks depends on the level of trust of the developer.

21. The method according to claim 20, comprising adapting/customizing said security frameworks depending on computing device end-user choices.

22. The method according to claim 15, comprising, once the right native application version for the targeted computing device/platform has been installed in said computing device memory, executing for first time the native application, said execution providing the notification notifies the computing device user about the network and device APIs the application is going to use.

23. The method according to claim 22, wherein said first execution also provides the computing device user means for allowing him to customize the prompting regime linked to the network and device APIs.

24. The method according to claim 23, comprising when the native application tries to use a device API, checking whether prompting is needed, and if so, the Device APIs RT Security Framework asks the user for authorization, and in case he allows it or no prompting is needed, the API usage will be authorized and the native capability will be granted and used.

25. The method according to claim 24, comprising when the native application tries to use a network API, the security framework checking if the usage of that API has been authorized before by the end-user, and:
i) if the usage has been authorized before, the security framework already knowing a developer token as well as an authorization token, and including both in a network request that is created based on the original developer call;
ii) if the usage has not been authorized or the authorization has expired the security framework checking the usage authorization of the APIs for said user, and if the authorization is not successful rejecting the request to access the Network APIs, and if it is successful the developer request is further processed as specified in i).

26. A system to generate and manage native applications, comprising means for performing at least said steps b) and c) of the method according to claim 15.

27. The system according to claim 26, comprising at least one of the next databases for managing different information needed for implementing the method:
Runtimes Database, in which said runtimes are available;
Rules Database, in which the transformation rules are available;
Devices Database, in which information about the supported OS and devices is stored;
Developers Database, in which developer information and credentials are available; and
Applications Database, in which generic and native applications are available.

28. The system according to claim 27, further comprising an application translator unit for performing the method, further comprising for every of said native application generation, performing said step b) for carrying out said bundling of runtimes or said bundling of runtimes and further actions, according to a workflow; and
starting said workflow by reading a delivered developer profile, the supported OSs, runtimes and security settings, and based on that, determining what is the workflow that the generic application should go through, said determination including the selection of the runtimes, security frameworks and transformation rules to be applied, from a plurality of runtimes, security frameworks and transformation rules, and the order of their performing.
